(19) United States
(12) Patent Application Publication
(10) Pub. No.: US 2008/0196842 A1
(43) Pub. Date: Aug. 21, 2008

(54) Roller Shutter

(75) Inventor: Leonardus Maria Lambertus Johannes Schoeren, Reuver (NL)

Correspondence Address: THE WEBB LAW FIRM, P.C., 700 KOPPERS BUILDING, 436 SEVENTH AVENUE, PITTSBURGH, PA, 15219, US

(73) Assignee: EUROPE LOOK BEHEER B.V., KC Reeuver (NL)

(21) Appl. No.: 11/791,444

(22) PCT Filed: Nov. 24, 2005
(86) PCT No.: PCT/NL2005/050052

§ 371 Date: Dec. 6, 2007

(30) Foreign Application Priority Data
Nov. 24, 2004 (NL) 1027584

(51) Int. Cl. E06B 9/15

(52) U.S. Cl. 160/133

(57) ABSTRACT

A roller shutter intended to be used in an opening in a building, such as a shop front opening, having a series of laths joined to one another such that they can pivot, a roller with respect to which the series of laths can be rolled up to expose the opening and can be rolled down to close the opening. The roller shutter also has guide rails that are located at the ends of the laths, in which guide rails the ends of the laths are accommodated such that they can move for guiding the laths over the opening. The end of each lath and the associated guide rails have anchors for anchoring the end of the lath against sideways movement out of said associated guide rails.

The invention relates to a roller shutter intended to be used in an opening in a building, such as a shop front opening, comprising a series of laths joined to one another such that they can pivot, a roller with respect to which the series of laths can be rolled up to expose the opening and can be rolled down to close the opening, as well as guide rails that are located at the ends of the laths, in which guide rails the ends of the laths are accommodated such that they can move for guiding the laths over the opening.

Such a roller shutter is known. They are usually used to protect shop premises against forcible entry. The roller shutters that are used for, for example, jewellers are known. Such roller shutters must meet many, sometimes conflicting, requirements. Thus, first of all a high strength is needed in order, for example, to achieve a sufficiently high degree of protection against extreme force that is associated with a so-called ram raid. In such cases a vehicle is used to break through the roller shutter.

On the other hand, it is specified by the Government that the roller shutters must have a certain degree of transparency. The aim of this regulation is to keep the appearance of, for example, shopping areas attractive, even when the roller shutters have been lowered after the shops have closed. In this context roller shutters that are of an open mesh type or have a transparent structure are usually used. The problem is that such roller shutters cannot easily meet the requisite strength requirements. In the case of a ram raid the laths are bent and eventually wrenched out of the guide rails, as a result of which the security function of the roller shutter is lost.

The aim of the invention is, therefore, to provide a roller shutter where the conflicting requirements cited above are met. Said aim is achieved in that the end of each lath and the associated guide rails have anchoring means for anchoring the end of the lath against sideways movement out of said associated guide rails.

In the case of the roller shutter according to the invention the laths are held firmly in the longitudinal guides fixed to the external wall. Even if a substantial force is exerted thereon transversely to the plane of the roller shutter, as can be the case in a ram raid, the ends of the laths cannot slip out of the longitudinal guides. The roller shutter consequently remains intact, even if this is bent out of its plane under the influence of a vehicle crashing into it. The security of the roller shutter is therefore substantially increased, even in the case of laths which, because of their nature, such as a perforated/punched model or a plastic material, are relatively less strong.

The anchoring means can have a wide variety of different constructions and be, for example, hook-shaped. An embodiment where the guide rails have an undercut cavity in cross-section and the end of the lath has a broadened head that fits in said cavity is mentioned as a further example. The broadened head is held back in the undercut cavity when an attempt is made to break through the roller shutter.

Furthermore, it is known to construct the guide rails as a slot-shaped section, the slot opening of which faces the lath. According to the invention with this arrangement the slot walls are provided with a constriction; in this case the lath comprises a lath body with a broadened head on either side, specifically such that the constriction is located between the broadened head and the lath body. The broadened head remains firmly secured behind the constriction, whilst the sliding movement of the laths remains possible during rolling up and rolling down.

The constriction can be made in various ways; a constriction with at least one bar oriented inwards in the slot or a constriction with two opposing bars oriented inwards in the slot are mentioned as examples.

According to a preferred embodiment the broadened head comprises an anchor pin as well as a broadening, such as a disc, the transverse dimension of which is greater than the transverse dimension of the constriction, fixed to the pin. In certain cases the broadened head can also be a track wheel. The broadening is preferably located between the track wheel and the lath body, such that it is not the relatively weak track wheel but the firmly welded-on or screwed-on disc that is capable of taking substantial forces that arise during burglary.

The diameter of the track wheel is preferably larger than the transverse dimension of the broadening. In that case the top of the guide rails can be provided with a slanted support track over which the track wheels can roll in a supported manner when the laths are rolled up or rolled down. The discs then run free of the support track, such that a smooth rolling-up or rolling-down movement is made possible.

According to a further embodiment the anchor means are connected to a hollow coupling tube for connecting the laths to one another such that they can pivot. A series of aligned pins can be located in the coupling tube. These pins provide the roller shutter with high strength against bending transversely to the plane of the roller shutter.

The invention will be explained in more detail below with reference to an illustrative embodiment shown in the figures.

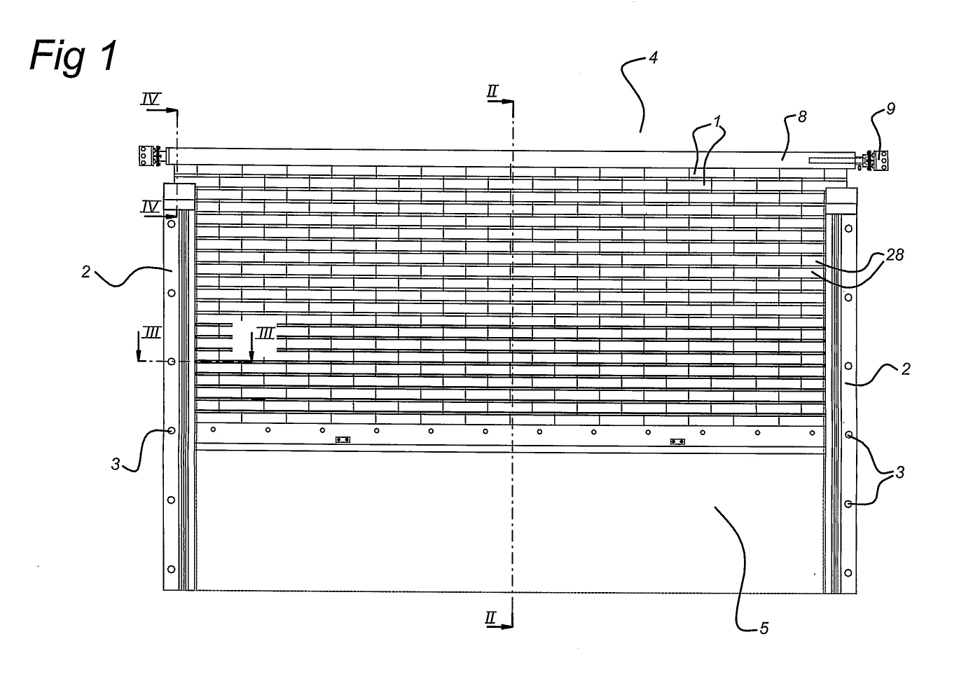

FIG. 1 shows a front view of the roller shutter according to the invention.

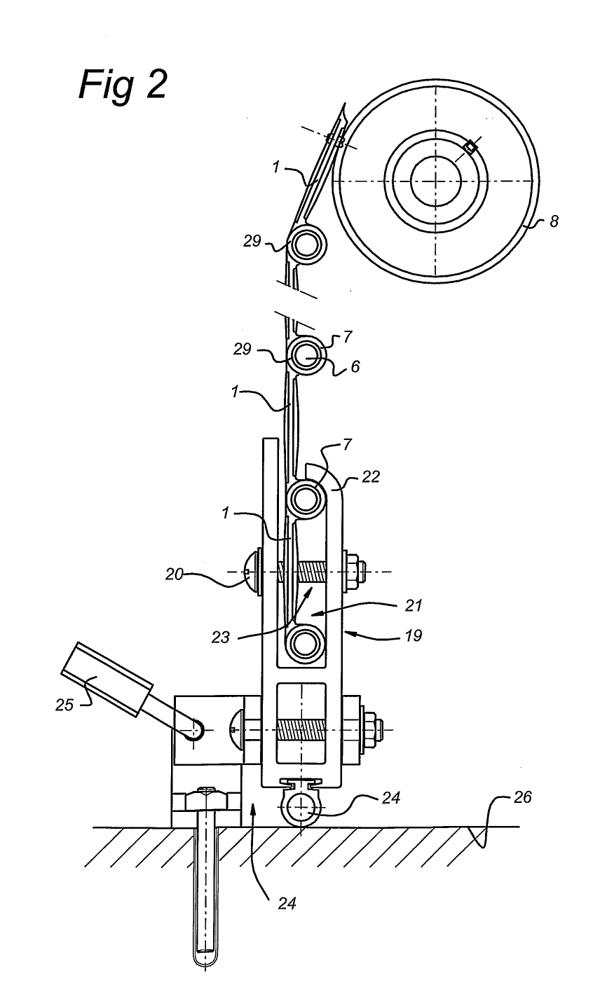

FIG. 2 shows a cross-section according to II-II in FIG. 1.

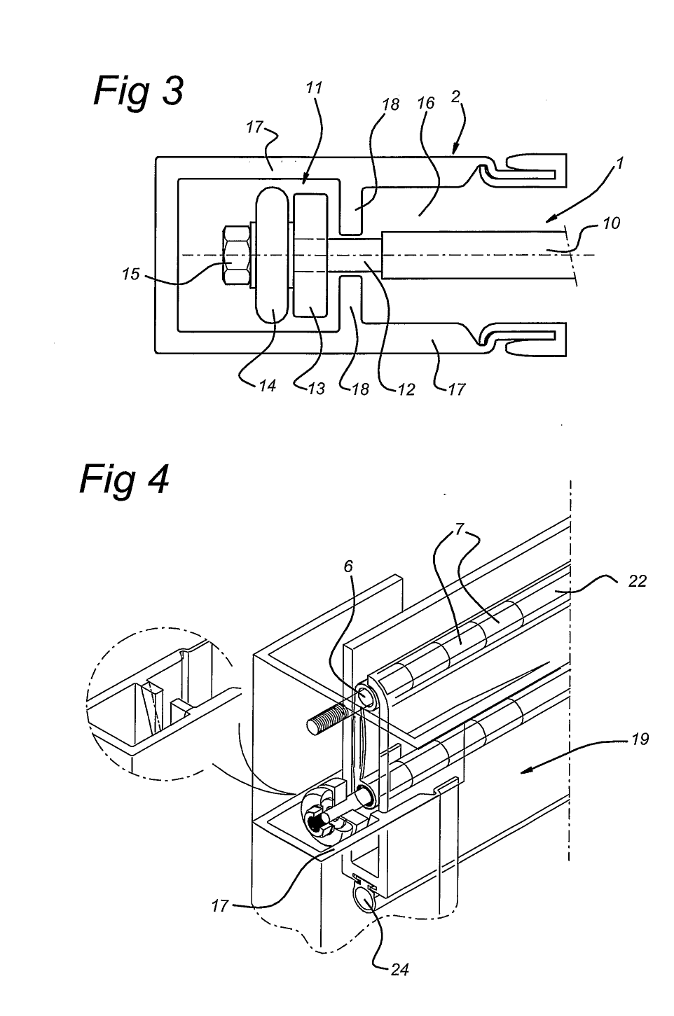

FIG. 3 shows a cross-section according to III-III in FIG. 1.

FIG. 4 shows the section according to IV-IV in FIG. 1.

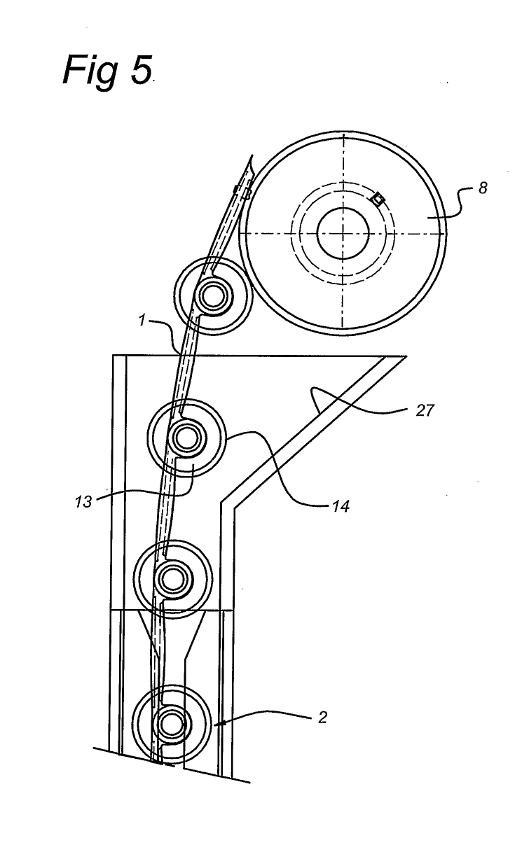

FIG. 5 shows an open view in perspective of part of the roller shutter according to the invention.

The roller shutter as shown in FIG. 1 comprises a series of laths 1 joined to one another such that they can pivot, the ends of which laths are accommodated in a guide rail 2. The guide rails 2 are firmly fixed to the external wall 4 of a building by means of bolts 3, so as to protect the opening, such as a shop front opening 5, in said building 4. The laths 1 are arranged in rows 28 offset with respect to one another in a brick-bond pattern.

As can be seen in the section in FIG. 2, the rows of laths are connected to one another by means of a hollow coupling tube 29. These coupling tubes 29 are inserted in eyes 7 positioned a regular distance apart along the edge of the laths 1, which eyes 7 are hooked into one another. The eyes 7 can also be seen in FIG. 5. The laths 1 can be rolled up by means of the roller 8, which can be driven by a tubular motor or a block motor 9. A guide rail 2 and the ends of the laths l are indicated in more detail in the section in FIG. 3. The laths 1 have a lath body 10 and a broadened head indicated in its entirety by 11. This broadened head comprises an anchor pin 12, to which a disc 13 has been welded or screwed. The track wheel 14 is fitted on the anchor pin 12 such that it can turn. These components are secured by means of the nuts 15 on the anchor pin 12.

The guide rail 2 consists of a slot-shaped section, the slot opening 16 of which faces the lath 1. The section has two parallel slot walls 17, with respect to which two bars extend inwards into the slot opening 16. The anchor pin 12 of each lath is accommodated between the ends of the bars 18 facing one another. As can be seen in FIG. 3, the bars 18 are located between the lath body and the disc 13. By virtue of this arrangement it is ensured that the laths l cannot be pulled out of the slot opening 16, for example should the laths bend under the influence of an impact load in the event of a ram raid. In this case the disc 13 is firmly held back behind the bars 18, so that, although it is able to deform, the roller shutter stays firmly attached to the external wall.

In the section in FIG. 2 it can also be seen that the bottom rail indicated in its entirety by 19 is fastened to the bottom lath 1. Said bottom rail has two upright walls 20, 21. One of the upright walls 21 has a curved collar 22 behind which the section 1 concerned is hooked. The bottom rail 19 and the lath 1 accommodated therein are firmly fastened to one another by means of the bolt/nut connections 23.

A rubber sealing strip 24 is provided at the bottom of the bottom rail. It is also shown that the bottom rail 19 is firmly connected to the floor 26 by means of the locking device 24 with padlock 25. The region of the roller shutter close to the bottom rail 19 is shown in more detail, in a partially exposed view, in FIG. 4.

In FIG. 5 it is shown that a lead-in funnel with a slanted support track 27 is connected above the guide rails 2. The track wheels 14 can run over this support track if the roller is displaced to the right.

Series of pins 6 to increase the flexural strength of the roller shutter and the resistance to impact loads are incorporated in the coupling tubes.

As an alternative, the bottom rail 19 can also be sunk in the floor, for example in a U section incorporated therein.

Slats can also be used instead of laths.

1-18. (canceled)

19. A roller shutter intended to be used in an opening in a building, comprising a series of laths joined to one another such that they can pivot, a roller with respect to which the series of laths can be rolled up to expose the opening and can be rolled down to close the opening, as well as guide rails that are located at the ends of the laths, in which guide rails the ends of the laths are accommodated such that they can move for guiding the laths over the opening, wherein the end of each lath and the associated guide rails have anchoring means for anchoring the end of the lath against sideways movement out of said associated guide rails.

20. The roller shutter according to claim 19, wherein the anchoring means are hook-shaped.

21. The roller shutter according to claim 19, wherein the guide rails have an undercut cavity in cross-section and the end of the lath has a broadened head that fits in said cavity.

22. The roller shutter according to claim 19, wherein each guide rail has a slot-shaped section with a slot opening which faces the lath, wherein slot walls of the slot opening are provided with a constriction and wherein the lath has a lath body with a broadened head on either side, such that the constriction is located between the broadened head and the lath body.

23. The roller shutter according to claim 22, wherein the constriction comprises at least one bar oriented inwards in the slot.

24. The roller shutter according to claim 22, wherein the constriction comprises two opposing bars oriented inwards in the slot-shaped opening.

25. The roller shutter according to claim 22, wherein the broadened head comprises an anchor pin as well as a broadening, the transverse dimension of which is greater than the transverse dimension of the constriction, fixed to the pin.

26. The roller shutter according to claim 25, wherein the broadened head also has a track wheel.

27. The roller shutter according to claim 26, wherein the broadening is located between the track wheel and the lath body.

28. The roller shutter according to claim 26, wherein the diameter of the track wheel is greater than the transverse dimension of the broadening.

29. The roller shutter according to claim 28, wherein the top of the guide rails is provided with a slanted support track over which the track wheels can roll in a supported manner, when the laths are rolled up or rolled down.

30. The roller shutter according to claim 19, wherein the laths are connected to one another by a hollow coupling tube.

31. The roller shutter according to claim 25, wherein the anchor pin is inserted in a coupling tube.

32. The roller shutter according to claim 31, wherein a series of pins extend in the hollow coupling tube.

33. The roller shutter according to claim 19, wherein the laths are made of a plastic material.

34. The roller shutter according to claim 19, wherein the laths are transparent, frosted or translucent.

35. The roller shutter according to claim 19, wherein the series comprises several rows of laths, which rows are joined to one another such that they can pivot.

36. The roller shutter according to claim 34, wherein the laths overlap one another in a brick-bond pattern.

37. The roller shutter according to claim 19, wherein the opening in the building is a shop front opening.

38. The roller shutter according to claim 25, wherein the broadening is a disc.
